(19) United States
(12) Patent Application Publication
(10) Pub. No.: US 2023/0208307 A1
(43) Pub. Date: Jun. 29, 2023

(54) FREQUENCY CONVERSION POWER TRANSMISSION SYSTEM

(71) Applicants: STATE GRID TAIZHOU POWER SUPPLY COMPANY, Zhejiang (CN); TAIZHOU ECONOMIC DEVELOPMENT ZONE TRANSPORTATION INSPECTION BRANCH OF TAIZHOU HONGDA ELECTRIC POWER, Zhejang (CN); GLOBAL ENERGY INTERCONNECTION RESEARCH INSTITUTE CO., LTD., Changping District Beijing (CN)

(72) Inventors: Jian YANG, Zhejiang (CN); Chen ZHOU, Zhejiang (CN); Zhanfeng DENG, Changping District Beijing (CN); Chi ZHANG, Zhejiang (CN); Zuofu JIANG, Zhejiang (CN); Guoliang ZHAO, Changping District Beijing (CN); Jianhua LV, Zhejiang (CN); Guode YING, Zhejiang (CN); Hongyang YU, Changping District Beijing (CN); Haohua WU, Zhejiang (CN); Jing GE, Changping District Beijing (CN); Yongling LI, Zhejiang (CN); Shaohua PAN, Zhejiang (CN); Qingxi CAI, Zhejiang (CN); Sanghong CHEN, Zhejiang (CN); Xin WANG, Zhejiang (CN); Yizhi ZHU, Zhejiang (CN); Chuhang XU, Zhejiang (CN); Xingbai WANG, Zhejiang (CN); Lijun ZHU, Zhejiang (CN); Xiaoyu XIANG, Zhejiang (CN); Baorong LIU, Zhejiang (CN); Xinghui JIANG, Zhejiang (CN); Linfeng GUAN, Zhejiang (CN); Yijun GUO, Zhejiang (CN)

(21) Appl. No.: 17/050,118

(22) PCT Filed: Jul. 8, 2020
(86) PCT No.: PCT/CN2020/100842

§ 371 Date: Oct. 23, 2020

(30) Foreign Application Priority Data
Jul. 10, 2019 (CN) 201910619164.5

(51) Int. Cl. H02J 3/38; H02M 5/16; H02M 5/22

(52) U.S. Cl. CPC H02J 3/381; H02M 5/16; H02M 5/225; H02J 2300/20

(57) ABSTRACT

A frequency conversion power transmission system includes: a new energy power generation base, a first isolation device, a second isolation device, an alternating current-alternating current (AC-AC) frequency conversion device and a power transmission cable; the new energy power generation base is configured to supply electrical energy to an AC power grid, and operate at a constant voltage and a constant or variable frequency according to environmental conditions including weather, an environment or a distance; the first isolation device is connected to the new energy power generation base; the second isolation device is connected to the AC power grid; an input terminal of the AC-AC frequency conversion device is connected to the first isolation device, an output terminal of the AC-AC frequency conversion device is connected to the second isolation device, and the power transmission cable is configured to connect the new energy power generation base and the first isolation device.

### CROSS-REFERENCES TO RELATED APPLICATIONS

This application is a national stage application filed under 35 U.S.C. 371 based on International Patent Application No. PCT/CN2020/100842, filed on Jul. 08, 2020, which claims priority to Chinese Patent Application No. 201910619164.5 filed with CNIPA on Jul. 10, 2019, the disclosures of which are incorporated herein by reference in their entireties.

### TECHNICAL FIELD

The present application belongs to the field of power supply, for example, a frequency conversion power transmission system.

### BACKGROUND

Energy is an important material basis of economic and social development. It has become a common strategic goal of all countries around the world to rapidly establish a safe and reliable, economical and efficient, clean and environmentally friendly modern energy supply system. To effectively solve the problems of energy depletion and environmental pollution, the development of new energy has become the only way to deal with the three major challenges of energy security, environmental pollution and climate change and achieve the sustainable development of human society. Wind power generation is one of the power generation manners which are most mature and have largest-scale development conditions among new energy power generation technologies. In some areas, wind power resources are distributed inversely against a load center, and large-capacity and long-distance power transmission is required to achieve the optimized distribution of resources.

At present, in a long-distance power transmission process, since cables, which are generally used for power transmission in offshore wind power interconnection, urban power supply and other occasions, have significant capacitive effects, the cables or electrical equipment tends to have some discharge phenomena, so that a power transmission system in the related art will have a decrease in insulation performance, which is not conducive to secure power transmission.

### SUMMARY

The present application provides a frequency conversion power transmission system which can avoid the case where a discharge phenomenon of cables or electrical equipment in a long-distance power transmission process results in a decrease in insulation performance of a power transmission system in the related art, which is not conducive to secure power transmission.

The frequency conversion power transmission system includes a new energy power generation base, a first isolation device, a second isolation device, an alternating current-alternating current (AC-AC) frequency conversion device and a power transmission cable.

The new energy power generation base includes power generation equipment that uses new energy, including at least one of wind energy, water power or solar energy, for power generation; and the new energy power generation base is configured to supply electrical energy to an AC power grid, and operate at a constant voltage and a constant or variable frequency according to environmental conditions including at least one of weather, an environment or a distance.

The first isolation device is connected to the new energy power generation base.

The second isolation device is connected to the AC power grid.

An input terminal of the AC-AC frequency conversion device is connected to the first isolation device, an output terminal of the AC-AC frequency conversion device is connected to the second isolation device, and the AC-AC frequency conversion device is configured to convert a three-phase voltage at a first frequency of the new energy power generation base into a three-phase voltage at a second frequency, where the first frequency is selected according to the environmental conditions and lower than the second frequency, and the second frequency is an industrial frequency and determined according to a power transmission requirement.

The power transmission cable is configured to connect the new energy power generation base and the first isolation device.

### BRIEF DESCRIPTION OF DRAWINGS

FIG. 1 is a first block diagram of a frequency conversion power transmission system;

FIG. 2A is a schematic diagram illustrating a first structure of an isolation device;

FIG. 2B is a schematic diagram illustrating a second structure of an isolation device;

FIG. 2C is a schematic diagram illustrating a third structure of an isolation device;

FIG. 2D is a schematic diagram illustrating a fourth structure of an isolation device;

FIG. 3 is a schematic diagram illustrating a circuit structure of an AC-AC frequency conversion device;

FIG. 4 is a schematic diagram illustrating a first circuit structure of a frequency conversion power transmission system;

FIG. 5 is a schematic diagram illustrating a second circuit structure of a frequency conversion power transmission system; and

FIG. 6 is a second block diagram of a frequency conversion power transmission system.

### LIST OF REFERENCE NUMBERS:

1. new energy power generation base; 2. power transmission cable; 3. first isolation device;

4. AC-AC frequency conversion device; 41. AC-AC frequency converter; 411. frequency conversion unit;
4111. inductor; 4112. H bridge; 42. switch group;
421. one group of switches; 5. second isolation device; 351. first connection structure; 352. second connection structure; 353. third connection structure; 354. fourth connection structure;
6. AC power grid; 7. step-up transformer; 8. filter device

### DETAILED DESCRIPTION

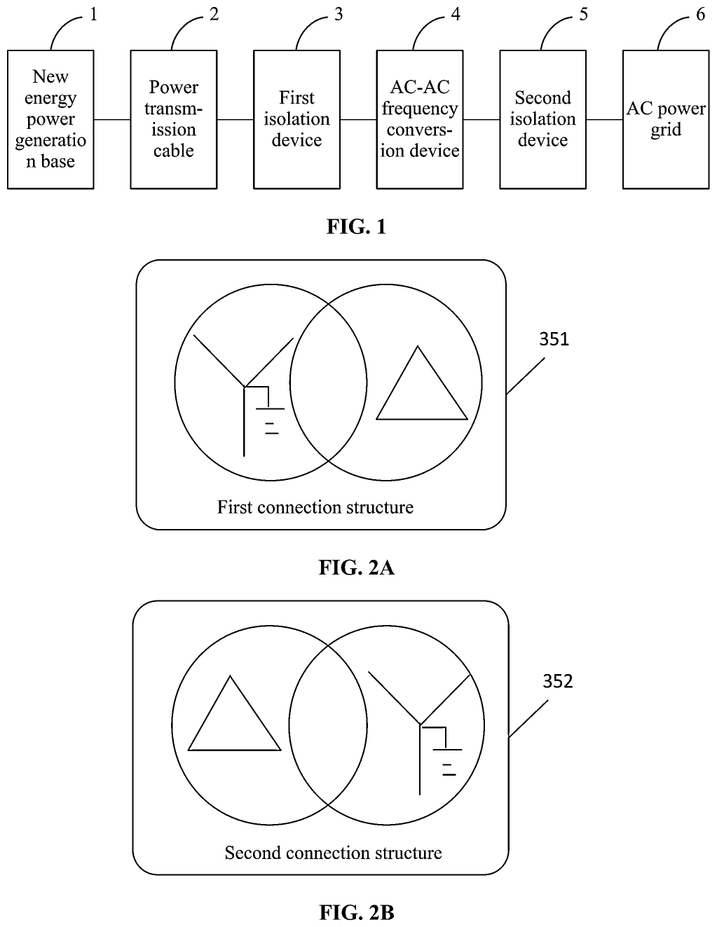

Aspects of the present application provide a power transmission system. As shown in FIG. 1, the power transmission system includes a new energy power generation base 1, a first isolation device 3, a second isolation device 5, an AC-AC frequency conversion device 4, and a power transmission cable 2.

The new energy power generation base 1 is configured to supply electrical energy to an AC power grid 6. The new energy power generation base 1 here may be composed of multiple offshore wind power stations, and may transmit the electrical energy generated by multiple wind power stations at an offshore low frequency to the AC power grid 6 on shore.

The first isolation device 3 is connected to the new energy power generation base 1, and the second isolation device 5 is connected to the AC power grid 6. Each of the first isolation device 3 and the second isolation device 5 here may be a two-winding transformer or a three-winding transformer. The two-winding transformer includes a first connection structure 351 or a second connection structure 352, and the three-winding transformer includes a third connection structure 353 or a fourth connection structure 354.

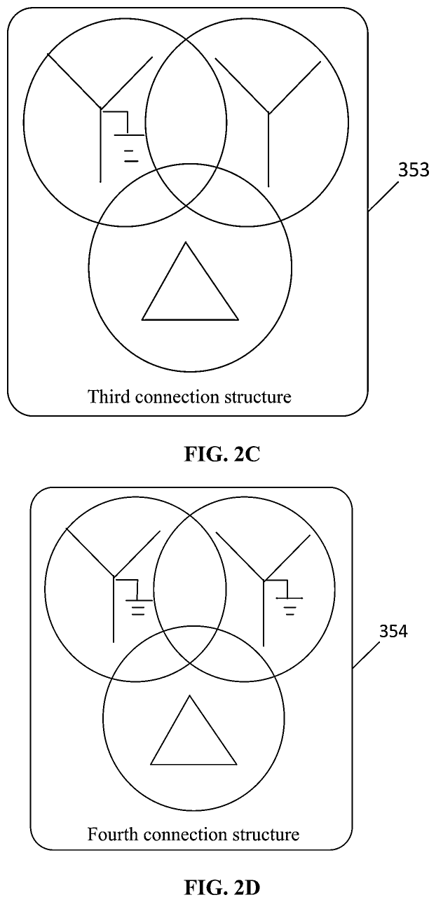

Referring to FIG. 2A, the first connection structure 351 is formed in the following manner: a primary winding of the two-winding transformer adopts a star connection, a neutral point of the primary winding is grounded, and a secondary winding of the two-winding transformer adopts a triangle connection. That is, when the two-winding transformer adopts the first connection structure 351 for winding connections, the winding connections are Y/Δ connections, where the neutral point of the primary winding is grounded. Windings of the two-winding transformer are connected in this manner, so as to improve isolation performance of the two-winding transformer, and thereby enhance the low-frequency power transmission security of the power transmission system.

As shown in FIG. 2B, the second connection structure 352 is formed in the following manner: the primary winding of the two-winding transformer adopts the triangle connection, the secondary winding of the two-winding transformer adopts the star connection, and a neutral point of the secondary winding is grounded. That is, when the two-winding transformer adopts the second connection structure 352 for winding connections, the winding connections are Δ/Y connections, where the neutral point of the secondary winding is grounded. The windings of the two-winding transformer are connected in this manner, so as to improve the isolation performance of the two-winding transformer, and thereby enhance the low-frequency power transmission security of the power transmission system.

As shown in FIG. 2C, a first winding of the three-winding transformer adopts a star connection, a neutral point of the first winding is grounded, a second winding of the three-winding transformer adopts the star connection, and a third winding of the three-winding transformer serves as a balance winding, so that the third connection structure 353 is formed. That is, when the three-winding transformer adopts the third connection structure 353 for winding connections, the neutral point of the first winding is grounded. Windings of the three-winding transformer are connected in this manner, so as to improve isolation performance of the three-winding transformer, and thereby enhance the low-frequency power transmission security of the power transmission system.

As shown in FIG. 2D, the first winding of the three-winding transformer adopts the star connection, the neutral point of the first winding is grounded, the second winding of the three-winding transformer adopts the star connection, a neutral point of the second winding is grounded, and the third winding of the three-winding transformer serves as the balance winding, so that the fourth connection structure 354 is formed. That is, when the three-winding transformer adopts the fourth connection structure 354, the neutral points of the first winding and the second winding are both grounded. The windings of the three-winding transformer are connected in this manner, so as to improve the isolation performance of the three-winding transformer, and thereby enhance the low-frequency power transmission security of the power transmission system.

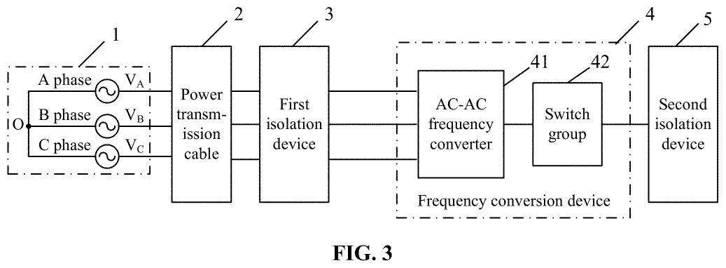

An input terminal of the alternating current-alternating current (AC-AC) frequency conversion device 4 is connected to the first isolation device 3, an output terminal of the AC-AC frequency conversion device 4 is connected to the second isolation device 5, and the AC-AC frequency conversion device 4 is configured to convert a three-phase voltage at a first frequency of the new energy power generation base 1 into a three-phase voltage at a second frequency. The new energy power generation base 1 here is generally an offshore wind power station, and outputs a low frequency, so the first frequency is lower than the second frequency. The AC-AC frequency conversion device 4 is configured to convert the three-phase voltage at the first frequency outputted by the new energy power generation base into the three-phase voltage at the second frequency, where the first frequency is lower than the second frequency. The power transmission system is applied to large-capacity and long-distance power transmission. Ranges of the first frequency and the second frequency are determined according to practical applications. The second frequency is lower than or equal to 75 Hz, and the first frequency is only required to be lower than the second frequency. For example, the second frequency is 60 Hz, and the first frequency may be any frequency lower than 60 Hz. For instance, the first frequency is a low-frequency power transmission frequency of 50/3 Hz. Since an industrial frequency of a power grid in China is 50 Hz, the second frequency is 50 Hz after frequency conversion, and the first frequency is set to 50/3 Hz. As the power transmission frequency increases, a current through a cable increases, and thus causing insulation performance degradation. After the effects of various factors such as insulation and costs are comprehensively considered, the low-frequency power transmission frequency of 50/3Hz is adopted. Such a setting can increase a transmission capacity by a factor of 3, reduce line impedance, and increase a transmission distance. As shown in FIG. 3, the AC-AC frequency conversion device 4 is included on a side of the AC power grid 6. As shown in FIG. 3, the three-phase voltage of the new energy power generation base 1 is represented as an A-phase voltage V_{A}, a B-phase voltage V_{B} and a C-phase voltage V_{C} respectively, where the three-phase voltage has a phase difference of 120 degrees. The converted three-phase voltage is represented as a first voltage VMA, a second voltage VMB and a third voltage VMC respectively, where the three-phase voltage has a phase difference of 120 degrees. The new energy power generation base 1 is generally built on an island, collects wind energy from various wind power stations, converts the wind energy into electrical energy, and outputs the electrical energy at a low frequency to the AC power grid 6 on shore.

In FIG. 3, the AC-AC frequency conversion device 4 includes an AC-AC frequency converter 41 and a switch group 42, where an input terminal of the AC-AC frequency converter 41 is connected to the new energy power generation base 1 through the first isolation device 3 and the power transmission cable 2. In FIG. 3, an output terminal of the AC-AC frequency converter 41 is connected to the second isolation device 5 through the switch group 42, and the switch group 42 is disposed between the output terminal of the AC-AC frequency converter 41 and the second isolation device 5. On one hand, such a setting facilitates the low-frequency power transmission between the new energy power generation base 1 and the AC power grid 6, switches in the switch group 42 are turned on, so that the new energy power generation base 1 accesses the power transmission system through the first isolation device 3. On the other hand, in the case where the power transmission cable 2 between the first isolation device 3 and the new energy power generation base 1 faults, the switches in the switch group 42 are turned off, so that the power transmission cable 2 and the new energy power generation base 1 are disconnected from the power transmission system, to facilitate maintenance and repair of the power transmission cable 2. The switch group 42 may be assigned according to the requirements of system protection and repair. The switch group 42 includes at least one group of switches, each group of switches includes three switches, and each switch includes a circuit breaker and isolation switches arranged at both ends of the circuit breaker, that is, an input terminal of the circuit breaker is connected to one isolation switch, and an output terminal of the circuit breaker is connected to another isolation switch. The number of switches may be set reasonably according to practical needs. In other specific implementations, the switch group 42 may further include three groups of switches.

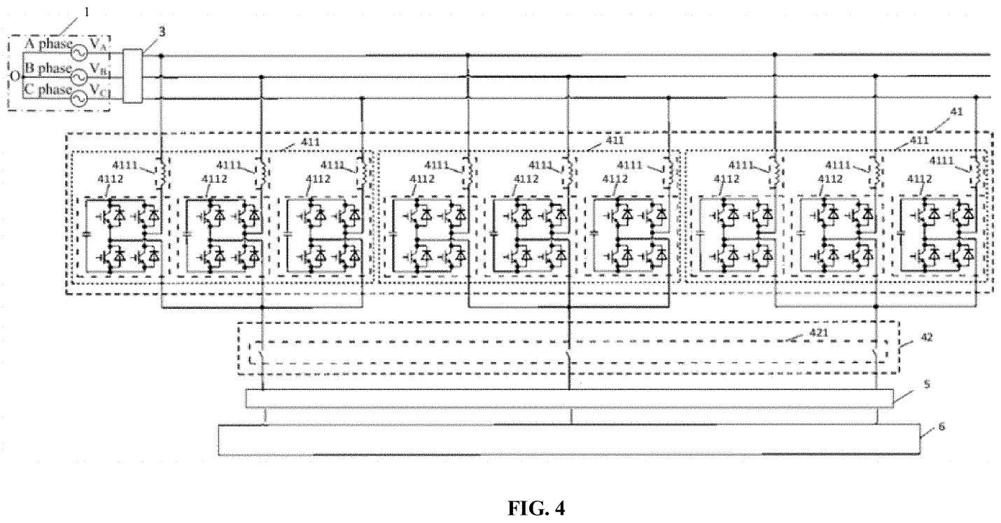

As shown in FIG. 4, the AC-AC frequency converter 41 includes at least one frequency conversion module, and each frequency conversion module includes three frequency conversion units 411, where an input terminal of the frequency conversion unit 411 is connected to the new energy power generation base 1 through the first isolation device 3, and an output terminal of the frequency conversion unit 411 is connected to the switch group 42 which is connected to the AC power grid 6 through the second isolation device 5. As shown in FIG. 4, the AC-AC frequency converter 41 includes one frequency conversion module, each frequency conversion module includes three frequency conversion units 411, the frequency conversion unit 411 includes three frequency conversion legs, and each frequency conversion leg includes an inductor 4111 and an H bridge 4112, where a first terminal of the inductor 4111 is connected to a first terminal of the H bridge 4112, a second terminal of the inductor 4111 serves as an input terminal of the frequency conversion leg, and a second terminal of the H-bridge 4112 serves as an output terminal of the frequency conversion leg; input terminals of the three frequency conversion legs are respectively connected to an A phase, a B phase and a C phase of the new energy power generation base 1 through the first isolation device 3, and output terminals of the three frequency conversion legs are connected to the switch group 42. The AC-AC frequency converter 41 includes 9 frequency conversion legs composed of H bridges 4112 and inductors 4111, where a three-phase low-frequency alternating current is outputted from neutral points of H bridges 4112.

Each H bridge 4112 includes at least one fully controlled H bridge 4112. In FIG. 4, each H bridge 4112 includes one fully controlled H bridge 4112, and each fully controlled H bridge 4112 includes two groups of legs of power electronic devices and a DC capacitor, where the two groups of legs of power electronic devices are connected in parallel, each leg of power electronic devices includes two power electronic devices connected in series, the DC capacitor is connected in parallel with the legs of power electronic devices, and the power electronic device includes an insulated gate bipolar transistor (IGBT) and a backpressure diode connected in parallel with the IGBT. The power electronic device may also be a metal-oxide-semiconductor (MOS) field effect transistor, a bipolar junction transistor (BJT) or the like, and be set reasonably as needed. Since the fully controlled H bridge 4112 can withstand a limited voltage level, and the voltage of the AC power grid 6 is relatively high, multiple fully controlled H bridges 4112 are required to be connected in parallel. In other implementations, the number of fully controlled H bridges 4112 connected in parallel may be set reasonably as needed.

In FIG. 4, one frequency conversion module may convert the three-phase voltage at the first frequency to the three-phase voltage at the second frequency which is connected to the AC power grid 6 through the switch group 42 and the second isolation device 5. When the switch group 42 connected to the frequency conversion module includes one group of switches, one frequency conversion module is connected to the AC power grid 6 of one AC system, and then the AC-AC frequency converter 41 is connected to one AC power grid 6.

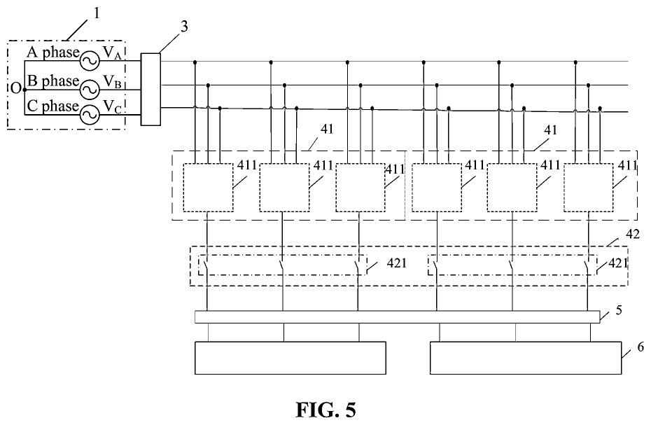

The AC-AC frequency converter 41 may include multiple frequency conversion modules, and the new energy power generation base 1 may be connected to the multiple frequency conversion modules. For example, as shown in FIG. 5, the AC-AC frequency converter 41 includes two frequency conversion modules, that is, two frequency conversion modules are connected in parallel. When the switch group 42 for each frequency conversion module includes one group 421 of switches, each frequency conversion module is connected to the AC power grid 6 of one AC system, and the AC-AC frequency converter 41 is connected to AC power grids 6 of two AC systems, so that the new energy power generation base 1 can provide low-frequency power transmission for the AC power grids 6 of two AC systems. When the switch group 42 for each frequency conversion module includes at least two groups of switches, each frequency conversion module is connected to AC power grids 6 of at least two AC systems, so that the new energy power generation base 1 can be connected to AC power grids 6 of multiple AC systems.

The power transmission cable 2 is configured to connect the new energy power generation base 1 and the first isolation device 3. The new energy power generation base 1 is connected to the AC power grid 6 through the power transmission cable 2, so that the electrical energy outputted by the new energy power generation base 1 is transmitted to the AC power grid 6.

In the power transmission system, the AC-AC frequency conversion device 4 converts the three-phase voltage at the first frequency of the new energy power generation base 1 into the three-phase voltage at the second frequency, where the first frequency is lower than the second frequency; then the three-phase voltage at the second frequency is transmitted to the AC power grid 6 through the power transmission cable 2 (not shown in the figures). The power transmission system adopts a power transmission frequency lower than the second frequency to increase the transmission capacity of the line in multiples and increase the transmission distance. In addition, the power transmission system reduces production costs during low-frequency transmission. The first isolation device 3 and the second isolation device 5 are respectively arranged on both sides of the AC-AC frequency conversion device 4, and the first isolation device 3 and the second isolation device 5 respectively adopt transformers with different connection structures, which can enhance isolation characteristics of the low-frequency power transmission, and thereby improve the low-frequency power transmission security.

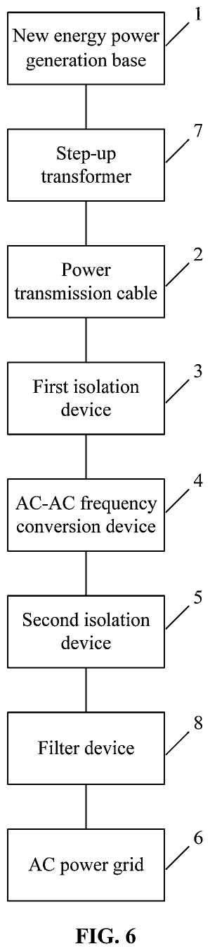

As an implementation, as shown in FIG. 6, the power transmission system further includes a filter device 8, where an input terminal of the filter device 8 is connected to the second isolation device 5, and an output terminal of the filter device 8 is connected to the AC power grid 6. The filter device 8 may be composed of a resistor-capacitance (RC) circuit or a resistor-inductor-capacitance (RLC) circuit. Since cables, which are generally used for power transmission in offshore wind power interconnection, urban power supply and other occasions, have significant capacitive effects, and even if the low-frequency power transmission is subjected to frequency conversion, the voltage after frequency conversion still has the interference of clutter, the filter device 8 may filter the clutter in the voltage, so that the low-frequency voltage is stably outputted to the AC power grid 6 for direct and normal use by residents.

As shown in FIG. 6, the power transmission system further includes a step-up transformer 7. The step-up transformer 7 is disposed between the new energy power generation base 1 and the first isolation device 3. A low-voltage side of the step-up transformer 7 is connected to the new energy power generation base 1, and a high-voltage side of the step-up transformer 7 is connected to the first isolation device 3 through the power transmission cable 2. For example, an AC voltage of the new energy power generation base 1 is 220 V, and the three-phase AC voltage of 220 V may be boosted to 10 kV through the step-up transformer 7, isolated by the first isolation device 3, and converted into the three-phase voltage by the frequency conversion device 4. The low-frequency transmission is performed by using a high-voltage power transmission line, and high-voltage power transmission can reduce heat losses due to a current and material costs of long-distance power transmission. The step-up transformer 7 may also boost the voltage to a different voltage such as 500 kV or 750 kV, which may be set reasonably as needed.

The power transmission system is used for power transmission transformation in remote areas or between multiple islands, which can increase a transmission capacity, reduce line losses, increase a transmission distance, save transformation costs, and reduce a construction difficulty. Moreover, the first isolation device 3 and the second isolation device 5 are used for electrical isolation of the low-frequency discharge in the power transmission line, which can ensure the low-frequency power transmission security.

The frequency conversion power transmission system can electrically isolate the low-frequency discharge of the power transmission cable during the low-frequency power transmission from the new energy power generation base to the AC power grid, thereby enhancing the low-frequency power transmission security.

1. A frequency conversion power transmission system, comprising: a new energy power generation base, a first isolation device, a second isolation device, an alternating current-alternating current (AC-AC) frequency conversion device and a power transmission cable; wherein
the new energy power generation base comprises power generation equipment that uses new energy, comprising at least one of wind energy, water power or solar energy, for power generation; and the new energy power generation base is configured to supply electrical energy to an AC power grid, and operate at a constant voltage and a constant or variable frequency according to environmental conditions comprising at least one of weather, an environment or a distance;
the first isolation device is connected to the new energy power generation base;
the second isolation device is connected to the AC power grid;
an input terminal of the AC-AC frequency conversion device is connected to the first isolation device, an output terminal of the AC-AC frequency conversion device is connected to the second isolation device, and the AC-AC frequency conversion device is configured to convert a three-phase voltage at a first frequency of the new energy power generation base into a three-phase voltage at a second frequency, wherein the first frequency is selected according to the environmental conditions and lower than the second frequency, and the second frequency is an industrial frequency and determined according to a power transmission requirement; and
the power transmission cable is configured to connect the new energy power generation base and the first isolation device.

2. The frequency conversion power transmission system according to claim 1, wherein each of the first isolation device and the second isolation device comprises a two-winding transformer and a three-winding transformer;
wherein the two-winding transformer comprises a first connection structure or a second connection structure, and the three-winding transformer comprises a third connection structure or a fourth connection structure.

3. The frequency conversion power transmission system according to claim 2, wherein a primary winding of the two-winding transformer adopts a star connection, a neutral point of the primary winding is grounded, and a secondary winding of the two-winding transformer adopts a triangle connection, so that the first connection structure is formed.

4. The frequency conversion power transmission system according to claim 2, wherein a primary winding of the two-winding transformer adopts a triangle connection, a secondary winding of the two-winding transformer adopts a star connection, and a neutral point of the secondary winding is grounded, so that the second connection structure is formed.

5. The frequency conversion power transmission system according to claim 2, wherein a first winding of the three-winding transformer adopts a star connection, a neutral point of the first winding is grounded, a second winding of the three-winding transformer adopts the star connection, and a third winding of the three-winding transformer serves as a balance winding, so that the third connection structure is formed.

6. The frequency conversion power transmission system according to claim 2, wherein a first winding of the three-winding transformer adopts a star connection, a neutral point of the first winding is grounded, a second winding of the three-winding transformer adopts the star connection, a neutral point of the second winding is grounded, and a third winding of the three-winding transformer serves as a balance winding, so that the fourth connection structure is formed.

7. The frequency conversion power transmission system according to claim 2, wherein the AC-AC frequency conversion device comprises an AC-AC frequency converter and a switch group; and
wherein an input terminal of the AC-AC frequency converter is connected to the first isolation device, and an output terminal of the AC-AC frequency converter is connected to the second isolation device through the switch group.

8. The frequency conversion power transmission system according to claim 7, wherein the AC-AC frequency converter comprises at least one frequency conversion module, wherein each frequency conversion module comprises three frequency conversion units, and wherein an input terminal of each of the three frequency conversion units is connected to the first isolation device, and an output terminal of each of the three frequency conversion units is connected to the second isolation device through the switch group.

9. The frequency conversion power transmission system according to claim 8, wherein each of the three frequency conversion units comprises three frequency conversion legs, and each of the three frequency conversion legs comprises an inductor and an H bridge, wherein a first terminal of the inductor is connected to a first terminal of the H bridge, a second terminal of the inductor serves as an input terminal of the frequency conversion leg, and a second terminal of the H-bridge serves as an output terminal of the frequency conversion leg; and
wherein input terminals of the three frequency conversion legs are respectively connected to an A phase, a B phase and a C phase of an output terminal of the new energy power generation base, and output terminals of the three frequency conversion legs are connected to the switch group.

10. The frequency conversion power transmission system according to claim 1, wherein the new energy power generation base comprises an offshore wind power station.
